(19) United States
(12) Patent Application Publication
(10) Pub. No.: US 2020/0244612 A1
(43) Pub. Date: Jul. 30, 2020

(54) CONTEXT ENABLED SENDER COMMUNICATION AWARENESS ALERT

(71) Applicant: International Business Machines Corporation, Armonk, NY (US)

(72) Inventors: Komminist Weldemariam, Nairobi (KE); Skyler Speakman, NAIROBI (KE); Itzhack Goldberg, HAIFA (IL); Shikhar Kwatra, RESEARCH TRIANGLE PARK, NC (US); Michelle Morales, YORKTOWN HEIGHTS, NY (US)

(21) Appl. No.: 16/257,583

(22) Filed: Jan. 25, 2019

(51) Int. Cl. H04L 12/58; G06N 20/00; H04L 29/06

(52) U.S. Cl. CPC H04L 51/26; G06N 20/00; H04L 63/0421; H04L 51/38; H04L 51/24

(57) ABSTRACT

A context-driven sender communication awareness method, system, and computer program product include detecting an intent of a sender sending an electronic communication to a receiver over a communication channel, establishing a potential risk to the receiver in connection with receiving the electronic communication on a device, determining an estimated time duration in which the established potential risk is applicable, and alerting the sender about the potential risk that results from delivering of the electronic communication within the estimated time duration.

### BACKGROUND

The present invention relates generally to a context-driven sender communication awareness method, and more particularly; but not by way of limitation, to a system, method, and computer program product for advising a potential message-sender (or caller) of the recipient status as another layer of distraction protection.

Conventionally, senders of an electronic communication (e.g., text messages, call, etc.) are not aware of the recipient's potential activity and how it may affect the recipient's concentration. That is, conventional techniques consider recipient end controls for message reception.

For example, some conventional techniques control. content and content sources according to situational context and provide some context-based alerts to the user. Specifically, such conventional techniques control electronic communication (e.g., messages, emails, notifications, calls, etc.) by suspending the content not to be shown to the receiver of the electronic communication or appearing on the notification panel or triggering messaging/email/social media app/etc. to stop syncing with their corresponding backend server by a receiver end based on the receiver's contextual situation (e,g., receiver is engaged in an activity such as coding, driving, in-custody, etc.).

However, none of the conventional techniques considers alerting the sender of the state of the receiver while protecting the receiver privacy.

### SUMMARY

Thus, the inventors have identified a need in the art for an improved technique for alerting of the sender(s) based on the receiver context so that the sender is aware that the receiver is in a state that. should not receive the message. That is, senders would benefit knowing the potential effect of sending a message and would be able to assess if the priority of the message overrides the distraction level that sending the text message may cause the recipient.

In an exemplary embodiment, the present invention provides a computer-implemented context-driven sender communication awareness method, the method including detecting an intent of a sender sending an electronic communication to a receiver over a communication channel, establishing a potential risk to the receiver in connection with receiving the electronic communication on a device, determining an estimated time duration in which the established potential risk is applicable, and alerting the sender about the potential risk that results from delivering of the electronic communication within the estimated time duration.

One or more other exemplary embodiments include a computer program product and a system, based on the method described above.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a context-driven sender communication awareness method 100 according to an embodiment of the present invention;

FIG. 2 exemplarily depicts how the sender device or graphical user interface (GUI) is controlled according to an embodiment of the present invention;

FIG. 3 exemplarily depicts a technique for training a machine learning model for context awareness according to an embodiment of the present invention;

FIG. 4 exemplarily depicts a decision tree according to an embodiment of the present invention;

FIG. 5 exemplarily depicts pseudo code for turning events into feature vectors and taking ameliorative action as part of relaying potential information to the sender based on predicting a receiver's context and/or engagement level;

FIG. 6 depicts a cloud-computing node 10 according to an embodiment of the present invention;

FIG. 7 depicts a cloud-computing environment 50 according to an embodiment of the present invention; and

FIG. 8 depicts abstraction model layers according to an embodiment of the present invention.

### DETAILED DESCRIPTION

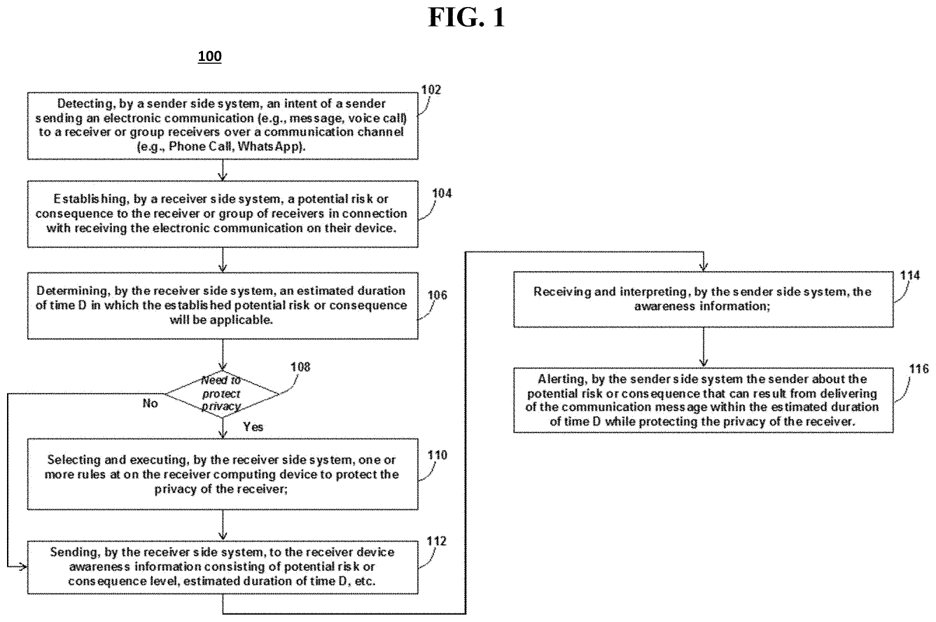

The invention will now be described with reference to FIGS. 1-8, in which like reference numerals refer to like parts throughout. It is emphasized that, according to common practice, the various features of the drawings are not necessarily to scale. On the contrary, the dimensions of the various features can be arbitrarily expanded or reduced for clarity.

By way of introduction of the example depicted in FIG. 1, an embodiment of a context-driven sender communication awareness method 100 according to the present invention can include various steps for alerting a sender about a potential risk or consequence that may result from delivering of a communication message within an estimated duration of time while protecting a privacy of the receiver.

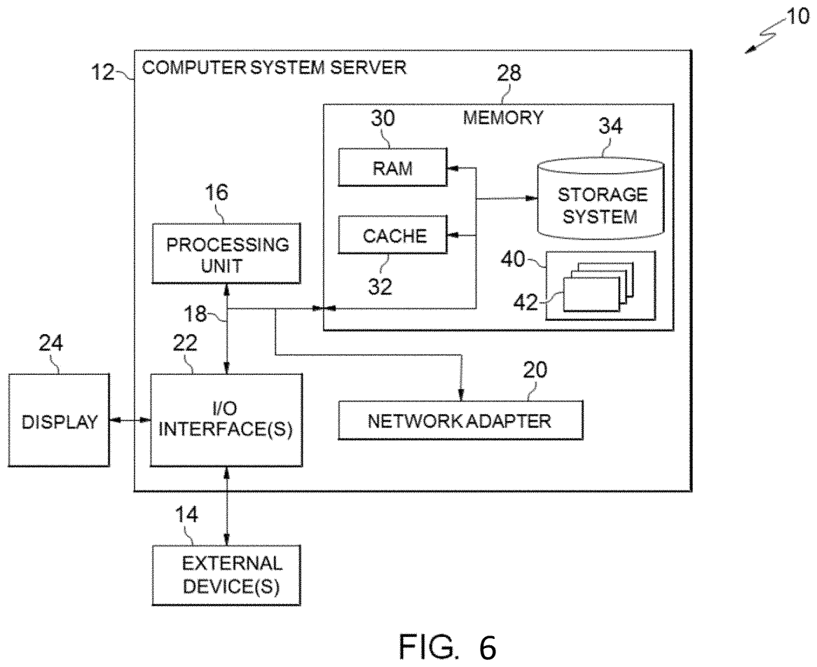

By way of introduction of the example depicted in FIG. 6, one or more computers of a computer system 12 according to an embodiment of the present invention can include a memory 28 having instructions stored in a storage system to perform the steps of FIG. 1.

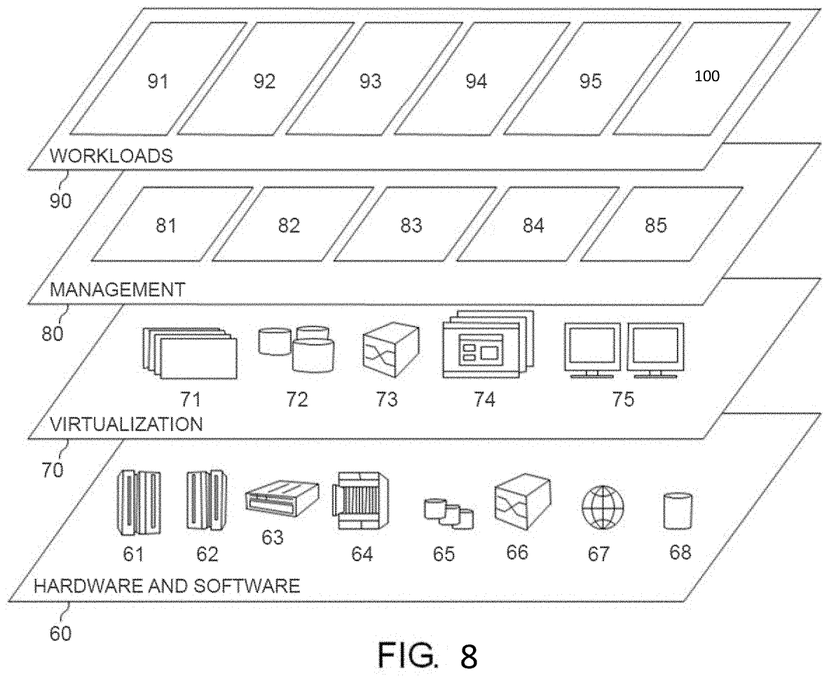

Although one or more embodiments may be implemented in a cloud environment 50 (e.g., FIG. 8), it is nonetheless understood that the present invention can be implemented outside of the cloud environment.

The method 100 may act in a more sophisticated and useful fashion, and in a cognitive manner while giving the impression of mental abilities and processes related to knowledge, attention, memory, judgment and evaluation, reasoning, and advanced computation. That is, a system is said to be “cognitive” if it possesses macro-scale properties—perception, goal-oriented behavior, learning/memory and action—that characterize systems (i.e., humans) that all agree are cognitive.

Cognitive states are defined as functions of measures of a host's total behavior collected over some period of time from at least one personal information collector (e.g., including musculoskeletal gestures, speech gestures, eye movements, internal physiological changes, measured by imaging circuits, microphones, physiological and kinematic sensors in a high dimensional measurement space, etc.) within a lower dimensional feature space. In one exemplary embodiment, certain feature extraction techniques are used for identifying certain cognitive and emotional traits. Specifically, the reduction of a set of behavioral measures over some period of time to a set of feature nodes and vectors, corresponding to the behavioral measures' representations in the lower dimensional feature space, is used to identify the emergence of a certain cognitive state(s) over that period of time. One or more exemplary embodiments use certain feature extraction techniques for identifying certain cognitive states. The relationship of one feature node to other similar nodes through edges in a graph corresponds to the temporal order of transitions from one set of measures and the feature nodes and vectors to another. Some connected subgraphs of the feature nodes are herein also defined as a “cognitive state”. The present application also describes the analysis, categorization, and identification of these cognitive states further feature analysis of subgraphs, including dimensionality reduction of the subgraphs, for example graphical analysis, which extracts topological features and categorizes the resultant subgraph and its associated feature nodes and edges within a subgraph feature space.

With reference to FIG. 1, the invention includes a context-driven sender communication awareness having a communication channel (e.g., a text message, voice call, etc.). In step 102, an intent of a user (sender) sending an electronic communication (e.g., message, voice call) to a secondary user (e.g., receiver) or group of users (e.g., receivers) detected. In step 104, a potential risk or consequence to the receiver or group of receivers in connection with receiving the electronic communication is established. In step 106, an estimated duration of time D in which the potential risk or consequence will be applicable is estimated. Finally, in step 116, the sender is alerted about the potential risk or consequence that can result from delivering of the communication message within the estimated duration of time D while protecting the privacy of the receiver.

The receiver cohort may be considered as part of the risk management (e.g., people with asthma, COPD, etc.) and one or more amelioration actions may be “learned” over time to control the sender activity or computing device.

Hence, by advising a potential message-sender or caller of the recipient's status, the invention adds another layer of ‘distraction protection’ that used to be solely based on the recipient end communication device (e.g., mobile phone) filtering rules.

Referring again to FIG. 1, privacy considerations be included. For example, in step 108, a decision is made whether there is a need to protect a privacy of the receiver or sender. If ‘YES’, then in step 110, on the receiver side of the system, one or more rules are selected and executed to protect the privacy of the receiver. If ‘NO’ or after the rules are selected, in step 112, awareness information is sent to the receiver device including a potential risk or consequence level, estimated duration of time, etc. In step 114, the awareness information is received by the sender side of the system and is interpreted. Then, the invention proceeds to step 116 above.

In one exemplary use case of the invention, Alice is driving to a doctor for a new patient appointment. Alice is driving and concentrating on following a global positioning system (GPS) and its directions. Alice's phone assesses that Alice is in a moving car due to speed of location changes, and also assesses that Alice is driving since the car is owned by Alice. Using history record(s) it can be determined whether this is a new route for the driver and as such her full attention to the road is required. Bob wants to send Alice a text message, “What are we having for dinner?”. Before Bob presses send, Bob's phone “consults” with the recipient phone about its owner's condition and assesses the importance/weight of that the text message destined for Alice, and further assesses that Alice is currently driving, which is an activity that could result in severe harm if distracted. Bob's phone can have a predefined danger level set to red/highest to alert him of the apparent distraction's danger. Bob's phone sends a notification to Bob, “Alice is driving [on a new road . . . ]. This text may be distracting and can result in an accident,” Bob decides not to send the text message.

That is, in the above exemplary use case, the condition of the receiver is consulted (assuming that a privacy setting between Bob and Alice is set such that Bob can receive information), and Bob receives a message stating that he should not send the message because it could harm Alice (i.e., cause an accident).

In one embodiment, the invention infers the intent of sending or calling a secondary user when the sender selects or a enters recipient's contact (e.g., phone number, name, account, etc.) and invokes a query on the recipient communication device. A system configured on the recipient side assesses the sender's activity to determine the situational context of the receiver and determine expected or predicted risk or consequence to the receiver. This can be done by using, for example, a Global Positioning System on a user device and one or more sensors of vehicle to assess location, speed, movement, destination—It is noted that if privacy issues are of concern, then the invention can use just the recipient speed (as derived from monitoring the GPS and the mobility of the car inferred from various sensors of the vehicle) instead of actual location, a biometric reading to assess activity level, mood, etc., historical user data such as a user profile, a historical context, a historical distraction levels, a history of accidents, etc.

In one embodiment, the invention may alert (e.g., in the form of a warning, notification, etc.) the sender of the recipient “condition” and potential distraction consequence level to the recipient. The sender may choose to either send/cancel the message. The recipient is made aware that the sender was warned (via pro-active alerts) about the consequence of sending the message, and still chose to send the message—indicating the sender's urgency/priority to disregard the recipient's wishes. For example, when receiving the message, the recipient will receive an “urgent” indicator (i.e., different color notification, exclamation point, etc.) with the message indicating the urgency of the message.

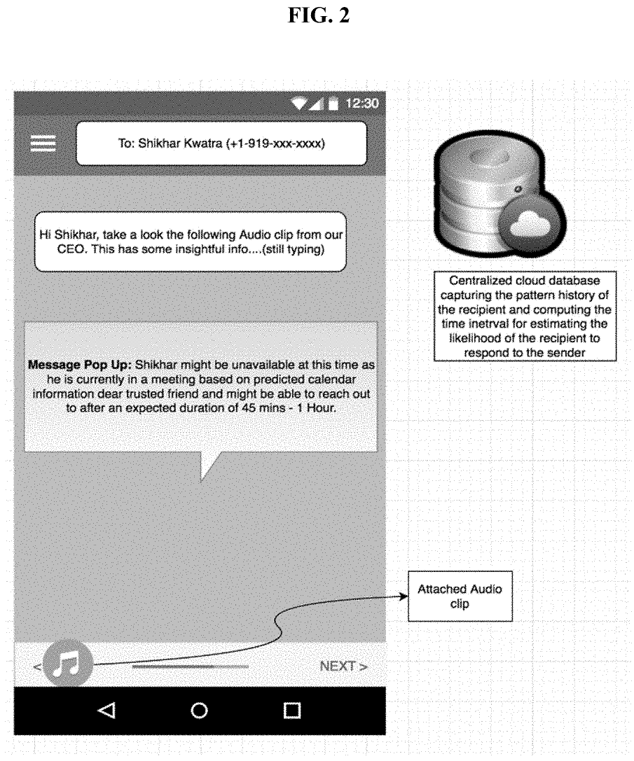

In one embodiment, the one or more rules of step 110 can include specifying the aspect of obfuscating or hiding the “privacy” of the user but letting the sender still know that he/she may not read a text message or answer to a call within an estimated duration of time D (such as is shown in FIG. 2). The estimated duration is computed based on (e.g., predicted) distracted duration time (i.e., the expected duration of the user to be in a distracted context). The invention may learn and preserve the privacy of the receiver from a plurality of data when notifying the one or more sender(s), if the user does not specify the rule. The sender is also notified about the “risk” or “danger” level if the receiver reads the message or picks up the call.

If the sender chooses to send the message or make the call after knowing the receiver may not act on the message or call, then an artificial intelligence (AI) agent running on the receiver device may prioritize messages and calls received during D time and replays to the receiver based on priority or urgency level. If necessary, the invention on the sender side may schedule the sending of the message (if the sender puts a draft) when it is the right time to send to the receiver (as D may be prolonged by activities at the receiver side).

The sender device may trigger a voicemail and a voice note about the activity of the user (if public) that can be shared with the “trusted” (e.g., to protect the privacy of the receiver) sender along with an estimated time to contact the recipient again. The invention further establishes the relationship between the sender and receiver to infer the trust level between them based on understanding the level of engagement and relationship of the two parties as well as the privacy rules that may be specified on the receiver device. The invention can also provide the best time to reach the recipient based on dynamically ingesting the receiver's pattern history and activities performed.

The technique of protecting the privacy of the receiver may include providing the user a mechanism (e.g., graphical user interface (GUI)) to specify or upload one or more rules on the receiver computing device. If the user does not specify the rule, then the invention may employ a machine-learning model to learn and preserve the privacy of the receiver from a plurality of data when notifying the one or more sender(s). The invention further learns one or more amelioration actions over time to control the sender's activity or sender's computing device when the established risk or consequence is above a certain threshold level.

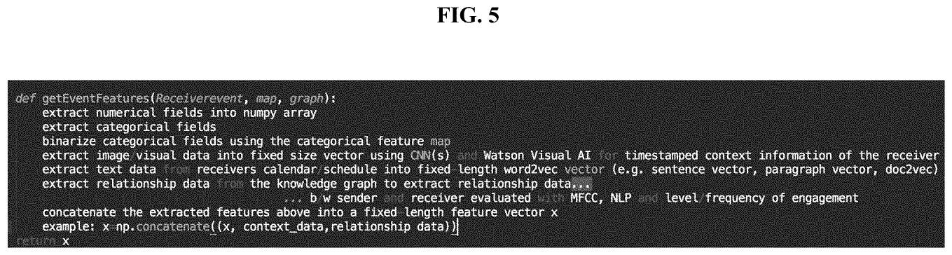

For example, with reference to FIG. 5, pseudo code is shown for turning events into feature vectors and taking ameliorative action as part of relaying potential information to the sender based on predicting the receiver's context and/or engagement level.

Through the monitoring and analysis of the receiver's real-time context, the invention may detect that the receiver is so emotional and confused, and expected incident risk level is ‘HIGH’. This information will be used to adjust the sender's phone or device. Some aspects of the invention may further relay the information to the sender regarding the estimated time when the receiver would pay heed to the message in a proactive fashion once the sender initiates typing of the message to the receiver. The content and the contact information are taken as an input into the content parser module, which understands the receiver information, gathers their predicted activities and run a threshold check against the receiver's activities. If the threshold is ‘high’, meaning that the receiver would not be near the phone or other linked devices or is busy in an important meeting, then the sender's device can be controlled (e.g., GUI can he blocked), and a pop-up notification can be displayed to the sender stating the estimated time that the recipient would be able to respond such as is shown in FIG. 2.

As another exemplary embodiment, a case on a phone can change color based on understanding the dynamic behavior of the parties engaged in the conversation and predicting the emotional state and pattern history of the receiver in order to proactively notify the sender about the receiver's state. For example, a sender's case being ‘red’ may show that it would be potentially unsafe to send a message with respect to the current receiver context. As such, the sender would be advisable to wait for a duration D time where D is a predicted duration in which the receiver is deemed to be safe to be able to receive a message (i.e., the case is ‘green’).

The alert may be provided by the device via sound, vibration, graphics, speech (e.g., an audio output of ‘Not a good time to send out this message. Better to send after 25 min!’, etc.), etc. The sender device may be equipped with a visual indicator to communicate the alert by changing color, changing intensity, blinking, etc.

In one embodiment, the monitoring and analyzing, in context, of the receiver cohort may include contextual analysis of the phone/device usage that may lead to a potential risk or consequence for the receiver (e.g., by detecting emergency situations from incoming text message sent, incoming tweets, incoming calls, incoming Facebook alerts, etc.) to make intelligent decisions while generating awareness alerts or tips to the sender or initiator of the electronic communication. Based on the detected risk of accident, the invention may provide to the sender of an electronic communication useful/recommended tips via sound, text or graphics. For example, the invention may detect that for the next 12 minutes that the user (i.e., the receiver) will be in a risky condition and also that the user has been historically distracted if she receives an electronic communication, “Please send the desired message after 12 minutes or confirm if the disclosed system can send for you after 12 minutes.” It is noted that the receiver cohort may include any of elderly person, teenager, while driving the person texting or just looking at screen, duration of looking at screen, nature of device, person wearing earbuds, person travelling alone or with a group of people, etc.

Based on the monitoring and analyzing (e.g., the invention detected that the user is so emotional and confused, and that the expected incident risk level is ‘HIGH’), a visual indicator on the user device/phone may change status, and the invention may also decide to lock the usage of certain electronic communication channels or apps (e.g., WhatsApp, Facebook Messenger, etc.) as shown in FIG. 2. This may discourage the user from sending the electronic message to the receiver or making a call.

The technique of establishing a potential risk or consequence to the receiver includes recording or monitoring risk events such as a location of the event, e.g. GPS coordinates, driving patterns, Wifi hotspots, street corner identification, identification of stairs, identification of a user's meeting from the user's calendar, current weather; current road conditions, current sidewalk conditions, noise/distraction levels, history of accidents, etc.

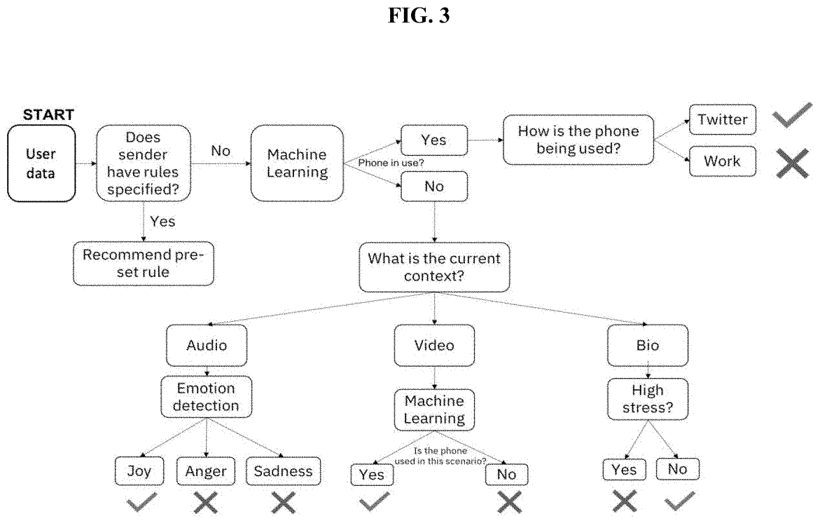

As one exemplary implementation of the invention, the invention may receive monitored and historical user data (e.g., user profile, context, etc.) and sensor data such as GPS, location, speed, movement, destination and location, patterns of phone usage, etc. Using the phone's microphone and video camera, audiovisual data can also be collected. Lastly, if the user of the device uses a compatible wearable device, such as an Apple Watch, bio-signals can also be monitored. Using the monitored and historical user data and sensor data, the invention may employ statistical machine-learning techniques to model and determine whether or not this is an appropriate time for the receiver to receive the message. FIG. 3 shows an implementation example.

As shown in FIG. 3, the invention would first check to see for a given sender if the receiver has defined one or more rules. Depending on the relationship between the sender and receiver the rule may define various actions. For example, “if it is Mom always let her message through”. The rule(s) can also set pre-defined levels of privacy. For example, “if it is Mom and I am busy send her as detailed a reason as possible for not being available to answer”. However, if no rules are specified, then the invention may self-learn to preserve the privacy of the receiver from plurality of data when notifying the one or more sender(s).

Next, with reference to FIG. 3, by considering the user data (e.g., phone usage data), the invention will use a machine-learning model trained on historical phone usage, to predict if the phone is currently in use. If it is in use, then the invention can check what type of application (i.e., Twitter®, work, etc.) is being used and depending on whether or not the message would be a distraction or not, the invention will make a recommendation to the sender to send (or not send) the message. For example, if the receiver is on Twitter® the message may not serve as a distraction. However if the user is working on a document or on an email during that time, the sender may want to wait before sending the message. If the phone is not in use, then the invention will leverage the multimodal data to make a recommendation, this recommendation will involve input from a few components.

With reference still to FIG. 3, audio data can be used for emotion detection of the receiver. Dependent on the identified emotion, the invention can make an appropriate recommendation. In addition, if the sender opts-in, then the message can also be analyzed for emotional content. If the receiver is currently in a negative emotional state and the sender's message is emotionally the counter-opposite, then the invention can recommend sending the message. If the receiver is currently in a positive emotional state and the sender's message is emotionally the counter-opposite, then the invention will recommend holding the message. Video data can be used to determine/learn context and past behavior in those contexts. The machine-learning model will be trained to predict whether or not given a certain context would the receiver use his/her device. Given the model's prediction, the invention will recommend sending or not send the message. If desired, if the user also uses a wearable device, bio-signal data can be monitored. High patterns in bio-signals (such as heart rate), could indicate high levels of stress and therefore the invention would recommend to the sender not to send the message. Therefore, the invention would ensemble the various recommendations into one ultimate recommendation, and use the predictions provided by the various models to provide the rationale behind the recommendation. Therefore, the invention would represent both a heuristic and machine learning-based system.

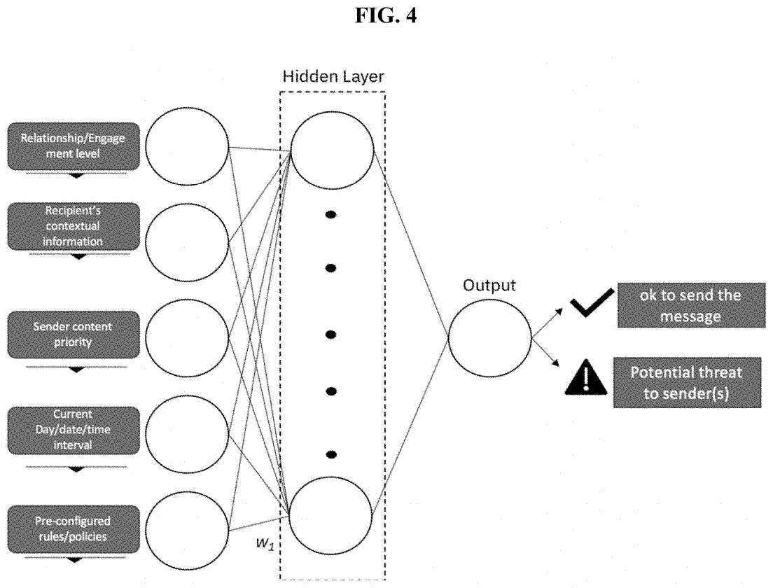

With reference to FIG. 4, the depicted neural network embodiment model highlights the aspect of monitoring activities of a cohort, study the relationship/engagement level of various users (senders and recipients) based on a level of engagement involving conversation frequency analysis, informal or formal conversation analysis based on conglomeration of natural language processing (NLP), Watson Text to speech transcription model service, sentiment analysis and Mel-frequency cepstral coefficient (MFCC) based speech features extraction for audio content analysis. Sender content priority is evaluated based on NLP and sentiment analysis of the message content being written in correlation with the relationship level in order to determine the right time to deliver the message to the respective recipient.

Weights and bias on the pre-configured rules module can be variably modified based on feedback learning which would include the how much information can be shared in the pop-up. For instance, if the sender is a trusted friend, then the appropriate time to send the message to the recipient is sent along with a reasoning regarding the potential threat (i.e., user is busy in a meeting with his manager and hence will be able to respond after 30-45 mins, so that might be the best time to send your message to the respective recipient).

In one embodiment, K-means clustering can be used to cluster profiles of a sender and a receiver based on understanding the trust and relationship level. If the user does not belong in the first cluster of trusted friends, then, only the time to contact the recipient will be shared with the respective user without any reasoning of the potential threat to contact the recipient at the moment.

Thus, the invention includes another layer of ‘distraction protection’ that used to be solely based on the recipient end communication device (e.g., mobile phone) by advising a potential message-sender or caller of the recipient status. The invention considers both the risk of the message when sent to the recipient and also considers the privacy of the recipient by not releasing information about the recipient without consent of the recipient (i.e., not releasing information to an unknown or unverified number whereas releasing information to a significant other).

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some eases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (Paas): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 6, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring now to FIG. 6, a computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further described below, memory 28 may include a computer program product storing one or program modules 42 comprising computer readable instructions configured to carry out one or more features of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may be adapted for implementation in a networking environment. In some embodiments, program modules 42 are adapted to generally carry out one or more functions and/or methodologies of the present invention.

Computer system/server 12 may also communicate with one or more external devices 14 such as a keyboard, a pointing circuit, other peripherals, such as display 24, etc., and one or more components that facilitate interaction with computer system/server 12. Such communication can occur via Input/Output (I/O) interface 22, and/or any circuits (e.g., network card, modern, etc.) that enable computer system/server 12 to communicate with one or snore other computing circuits. For example, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

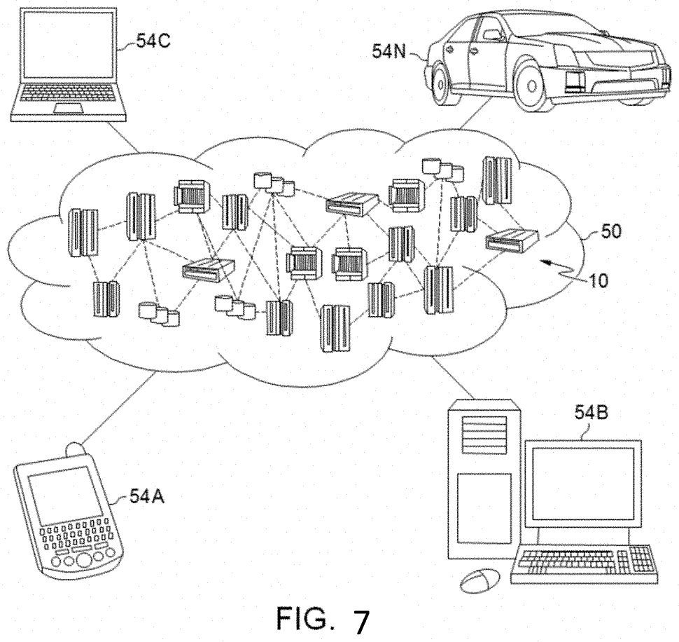

Referring now to FIG. 7, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 7 are intended to be illustrative only and that computing nodes 10 and cloud computing environment 50 can communicate with any type of computerized circuit aver any type of network and/or network addressable connection (e.g., using a web browser).

Referring now to FIG. 8, an exemplary set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

in one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and context-driven sender communication awareness method 100 in accordance with the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented context-driven sender communication awareness method, the method comprising:
detecting an intent of a sender sending an electronic communication to a receiver over a communication channel;
establishing a potential risk to the receiver in connection with receiving the electronic communication on a device;
determining an estimated time duration in which the established potential risk is applicable; and
alerting the sender about the potential risk that results from delivering of the electronic communication within the estimated time duration.

2. The method of claim 1, wherein the alerting alerts the sender about he potential risk while protecting a privacy of the receiver.

3. The method of claim 1, wherein the establishing the potential risk to the receiver includes learning a contextual situation of the receiver based on real-time monitoring and historical data using a machine learning model.

4. The method of claim 1, wherein the establishing considers a receiver cohort as part of establishing the potential risk.

5. The method of claim 1, further comprising learning one or more amelioration actions over time to control the sending the electronic communication when the established potential risk is greater than a threshold level.

6. The method of claim 1, wherein the alerting alerts the sender via at least one of:
a sound;
a vibration of a sender device; and
a manipulation of a coloring of a case on the sender device.

7. The method of claim 1, wherein a characteristic sent by the alerting on a sender device is adjusted by monitoring and analyzing a receiver real-time context.

8. The method of claim 1, embodied in a cloud-computing environment.

9. A computer program product for context-driven sender communication awareness, the computer program product comprising a computer-readable storage medium having program instructions embodied therewith, the program instructions executable by a computer to cause the computer to perform:
detecting an intent of a sender sending an electronic communication to a receiver over a communication channel;
establishing a potential risk to the receiver in connection with receiving the electronic communication on a device;
determining an estimated time duration in which the established potential risk is applicable; and
alerting the sender about the potential risk that results from delivering of the electronic communication within the estimated time duration.

10. The computer program product of claim 9, wherein the alerting alerts the sender about the potential risk while protecting a privacy of the receiver.

11. The computer program product of claim 9, wherein the establishing the potential risk to the receiver includes learning a contextual situation of the receiver based on real-time monitoring and historical data using a machine learning model.

12. The computer program product of claim 9, wherein the establishing considers a receiver cohort as part of establishing the potential risk.

13. The computer program product of claim 9, further comprising learning one or more amelioration actions over time to control the sending the electronic communication when the established potential risk is greater than a threshold level.

14. The computer program product of claim 9, wherein the alerting alerts the sender via at least one of:
a sound;
a vibration of a sender device; and
a manipulation of a coloring of a case on the sender device.

15. The computer program product of claim 9, wherein a characteristic sent by the alerting on a sender device is adjusted by monitoring and analyzing a receiver real-time context.

16. A context-driven sender communication awareness system, the system comprising:
a processor; and
a memory, the memory storing instructions to cause the processor to perform:
detecting an intent of a sender sending an electronic communication to a receiver over a communication channel;
establishing a potential risk to the receiver in connection with receiving the electronic communication on a device;
determining an estimated time duration in which the established potential risk is applicable; and
alerting the sender about the potential risk that results from delivering of the electronic communication within the estimated time duration.

17. The system of claim 16, wherein the alerting alerts the sender about the potential risk while protecting a privacy of the receiver.

18. The system of claim 16, wherein the establishing the potential risk to the receiver includes learning a contextual situation of the receiver based on real-time monitoring and historical data using a machine learning model.

19. The system of claim 16, wherein the establishing considers a receiver cohort as part of establishing the potential risk.

20. The system of claim 16, embodied in a cloud-computing environment.
